(19) United States
(12) Patent Application Publication
(10) Pub. No.: US 2003/0138021 A1
(43) Pub. Date: Jul. 24, 2003

(54) Diode-pumped solid-state thin slab laser

(76) Inventors: Norman Hodgson, San Francisco, CA (US); Hanna J. Hoffman, Palo Alto, CA (US); Wilhelm A. Jordan, Foster City, CA (US)

Correspondence Address: HELLER EHRMAN WHITE & MCAULIFFE LLP, 275 MIDDLEFIELD ROAD, MENLO PARK, CA, 94025-3506, US

(21) Appl. No.: 10/294,997

(22) Filed: Nov. 13, 2002

Related U.S. Application Data
(63) Continuation-in-part of application No. 10/035,805, filed on Oct. 25, 2001.
(60) Provisional application No. 60/332,666, filed on Nov. 13, 2001.

(51) Int. Cl. H01S 3/091

(52) U.S. Cl. 372/75

(57) ABSTRACT

An edge-pumped solid state thin slab laser apparatus is disclosed that is power scalable to well over 150 W for either multimode or near single transverse mode operation. A slab thickness is selected that is small enough to minimize thermal effects for a straight through beam yet large enough to allow efficient direct coupling of pump light from high power diode array stacks while also keeping the gain to within manageable levels for pulsed operation. Cooling of the slab is provided conductively, preferably by contact with metal blocks of high thermal conductivity. The edge-pumped solid state thin slab laser provides a near-one dimensional temperature gradient and heat flow direction that is perpendicular to the laser signal plane of propagation. The width of the slab is selected so as to maximize pump absorption length for a given laser material and both one and two-sided pumping schemes can be accommodated by the basic slab laser platform, depending on power, mode and beam quality requirements. The output power from the edge-pumped thin slab is generally scalable with slab length and the power available from diode array stacks used to pump the slab. The broad faces of the slab comprising the active medium may be coated with a material that is reflective at the pump wavelength or the slab can be sandwiched between two layers of dielectric of lower index of refraction so as to allow guiding of the pump light for better homogenization of the absorption, and hence the gain profile.

### CROSS-REFERENCE TO RELATED APPLICATIONS

This application claims the benefit of U.S. Serial No. 60/332,666, filed Nov. 13, 2001, and is also a continuation-in-part of U.S. Ser. No. 10/035,805, filed Oct. 25, 2001, both of which applications are fully incorporated herein by reference.

### BACKGROUND

1. Field of the Invention

This invention relates to diode-pumped solid state lasers and more particularly to power scalable diode-pumped slab lasers compatible with high beam quality and high brightness outputs.

2. Description of the Related Art

Over the past decade, diode-pumped solid state lasers (DPSSL) have been increasingly utilized in applications that require high output power and high beam quality. In standard laser configurations, the optical resonator contains active material configured as an elongated rod with either round or rectangular cross-sectional dimensions on the order of 1-10 mm in either direction perpendicular to the optical axis. These axially-symmetric “rods” may be side- or end-pumped by diode lasers, fiber coupled diode lasers, or diode laser bars. The state of the art for diode pumped lasers based on rod configurations ranges from 50 W for Q-switched DPSSL 's with near-diffraction-limited (NDL) beam quality to just over 200 W for highly multimode outputs using multiple gain media and complex pumping arrangements. It is well known that axially-symmetric rod based laser configurations exhibit a fundamental limitation in regards to both output power and beam quality. For typical crystalline laser rods, such as YAG, fracture occurs when the output power exceeds about 60 W per cm of length. The fracture limit is still lower for other commonly used materials such as YVO₄ and YLF. For single mode operation, as provided for example by the TEM₀₀ mode of a stable resonator, the output power is further limited due to beam size and mode matching considerations. Thus, it is generally known in the art that even for a high gain material such as Nd:YVO₄, the TEM₀₀ power is limited to less than about 30 W per rod, if the resonator is required to be stable over a wide pump power range. For lower gain rods, such as the commonly utilized Nd:YAG, the power limit for stable TEM₀₀ operation reduces to less than about 20 W. Higher TEM₀₀ mode output powers from rod geometries can be achieved only by limiting the pump power range over which the resonator is stable. Even use of direct pumping into the upper laser level may extend the aforementioned limits only by about 30%. Consequently, the axially symmetric rod geometry fundamentally limits the attainable output power for high brightness beams to 100 W at the most.

A more favorable geometry for high power operation is provided by rectangularly shaped slabs, which are not constrained by axial symmetry considerations. The fracture limit of slab lasers is known to be higher as compared to a rod by half the aspect ratio w/t where w is the width of the slab and t is its thickness. This is the result of larger surface to volume ratio and a smaller temperature difference across the thinner dimension, which sets up a near one-dimensional temperature gradient. Generally, the larger the aspect ratios the more favorable the heat dissipation profiles. Thus, a thinner slab is particularly effective in minimizing the effects of thermally-induced distortions and stress birefringence, allowing thermal lensing to be compensated through various means known in the art of resonator design across a full operational power range. On the other hand, thin slabs presented certain difficulties to high pumping efficiencies due to unfavorable design trade-offs between efficiency, power and output beam brightness.

For example, the prior art recognizes many different designs employing zigzag compensation schemes in high power optical oscillators and amplifiers. In most such cases, the laser beam is made to travel along a zigzag path within slabs of relatively small aspect ratios by way of total internal reflection (TIR) at the faces of the slab. The key premise behind all methods based on the zigzag approach is that as long as the temperature gradient is along the same plane as the direction of beam propagation, residual thermally induced variations of the index of refraction are substantially averaged out as the zigzag path moves across different temperature regions, at least to first order. Consequently, it was hoped that good beam quality will be attained at high powers even from slabs with relatively small aspect ratios, as manifested by slab dimensions which typically vary from 10-30 mm in width and 1.5 -8 mm in thickness. Most commonly, the slab was side-pumped by a plurality of diode laser bars positioned along the broader faces, as was disclosed for example in U.S. Pat. No. 5,900,967. Such configurations were readily scaleable to high powers but required complex cooling and pumping arrangements. Alternatively, edge-pumped configurations could be utilized, with the diode pump light coupled into the slab along a direction parallel to the cooled surfaces. Such an edge-pumped configuration has the advantage of separating the pumped and cooled surfaces while allowing for simultaneous optimization of both pump power and absorption as was described, for example, in U.S. Pat. No. 6,134,258. Still another alternative to zigzag slab lasers utilizes end-pumping in which the pump light is aligned with the laser beam resulting in high absorption efficiencies. An example of this configuration was taught in U.S. Pat. No. 6,268,956.

Although considerable progress was made in the past few years in scaling the output power and improving the beam quality obtained from zigzag slab lasers and amplifiers, employing the various configurations as noted above, major issues remain. In particular, the zigzag slab is known to be susceptible to edge effects and warping, a problem common to all pumping schemes. The relatively large slab shaped active materials described in the art also require a high degree of parallelism to support the TIR path, which render them expensive to fabricate and manufacture. Furthermore, the TEM₀₀ output power is fundamentally limited, due to a mismatch between the mode and the slab with its typically have relatively large cross-section. This mismatch could, in principle, be overcome by using unstable resonators, which have the unique property that near diffraction limited beam quality can be attained regardless of the transverse dimensions of the active medium. However, even with unstable resonators, near single mode performance from slab lasers has been disappointing. The difficulties were attributed primarily to edge effects and residual optical aberrations due to thermal strain caused by pumping and cooling induced non-uniformities. Attempts to confine the pump light into the center portion of the slab thereby avoiding edge effects generally required fabrication of complex composite materials with doped and undoped end-sections that are not readily manufacturable.

Alternative solutions to the thermal lensing and stress birefringence problems associated with high power operation are known in the art. One approach to improving the beam quality from slab lasers included the use of lasers with aspect ratios large enough to allow one dimensional temperature gradients and thin enough to minimize unwanted thermal lensing effects or stress birefringence without zigzag path and deleterious edge effects. One approach described in the prior art (see G. Schnitzler et. Al. in Advanced Solid State lasers, OSA TOPS Vol. 50, pp. 5-10, 2001) utilizes line-shaped end-pumping using micro-optics to image radiation from diode laser stacks into a Nd:YAG slab. This approach provides a thin gain cross section with a high enough aspect ratio to allow the desired quasi-one-dimensional heat conduction. However, scaling from this approach may be limited, due to increasing complexity of the beam shaping optics and unfavorable trade-offs between pump absorption, pumped versus unpumped volume ratios and the gain-length product, the latter being especially critical for Q-switched operation. Sensitivity to doping and pump inhomogeneities may impose further restrictions on the power and beam quality attainable, limitations that are common to most end-pumped architectures.

Another alternative employ using straight-through slab approach is based on pumping a planar waveguide laser wherein the circulating laser light is guided over at least a portion of the propagation path. Such waveguide configurations generally do not obey the laws of free space propagation and may allow, with carefully selected optical designs, operation in low-order or NDL mode even from active material structures that are spatially multimode in nature. Slab waveguides have been successfully employed in scaled CO₂ lasers. A waveguide slab CO₂ laser is generally configured with electrode separation small enough to cause waveguiding of the laser beam along only one dimension of the discharge volume, while propagating freely in the wider dimension. Since the large aspect ratios common in this type of laser result in very different mode properties in the x and y directions, much of the work in this area concentrated on development of hybrid resonator designs characterized by optical configurations that are stable in one direction and unstable in the perpendicular direction.

For example, U.S. Pat. No. 4,719,639 issued to Tulip discloses, for the first time a CO₂ slab waveguide laser comprising an unstable resonator structure in the unconfined direction but a stable waveguide resonator in the guided direction. The unstable resonator described by Tulip includes one concave and one convex mirror and is known in the art as a positive branch unstable resonator. Another slab waveguide resonator structure was described in U.S. Pat. No. 4,939,738 issued to Opower which was also provided with a positive branch unstable resonator in the non-waveguide direction. By contrast, U.S. Pat. No. 5,335,242 issued, for example, to Hobart et al and U.S. Pat. No. 5,353,297 issued to Koon et al disclose CO₂ slab waveguide lasers having a negative branch unstable resonator in the non-waveguiding direction. Such resonator constructions allow the resonator mirrors to be spaced sufficiently apart from the ends of the guide to provide more optimal coupling of the circulating laser light into the guide while minimizing mirror degradations due to the discharge. Negative branch unstable resonators are also known to be less alignment sensitive than their positive branch counterparts, as is well known in the art. Constructions based on both positive-branch and negative branch resonators were successfully implemented in commercial packages for different sealed-off CO₂ slab lasers, depending on power levels and size requirements. High average powers (up to 2.5 kW) with good beam quality characteristics are now available from commercial CO₂ lasers such as the Diamond Model manufactured by Coherent, Palo Alto, Calif.

More recently, waveguide lasers have also been demonstrated as an efficient means to generate high brightness output beam from solid state media. In particular, composite configurations wherein the waveguide slab is sandwiched between one or more matching stacks of dielectric materials of lower indices of refraction than the active laser material were used to confine either or both pump and signal light. Generally, the signal beam is guided along the thin direction if the Fresnel number—defined as a²/λL—is much smaller than unity. For typical solid state gain media with an emission wavelength near 1 μm, the required thickness for a waveguide slab geometry is smaller by about an order of magnitude than the 1-2 mm typically utilized for 10 μm CO₂ lasers of similar length. In addition, most dielectric materials employed for confining the signal within an active layer do not provide the transverse mode discrimination available from the metallic or ceramic coated waveguides used for CO₂ and other gas lasers. Consequently, single mode waveguides are generally required for extraction of good beam quality from solid state planar dielectric waveguide lasers. To force laser oscillation in the lowest order mode means that the thickness of the active slab laser material must therefore be limited to 5-10 times the laser emission wavelength, i.e., less than 10 microns for standard 1 μm Nd or Yb-doped active media. For example, an 8 μm single mode active core was found capable of providing 12 W output in a single fundamental mode from an Yb:YAG waveguide using a composite double-clad diffusion-bonded structure, constructed according to principles described in U.S. Pat. No. 6,160,824 to Meissner. It is however recognized that, whereas such thin waveguide constructions may be advantageous for high threshold and/or low gain systems, such as the quasi-three level Yb:YAG, (due to lower thresholds and improved overlap between pump and signal), they are not conducive to power scaling to the >100 W levels of interest herein.

Furthermore, power scaling from such cladding-pumped thin waveguide structures may be gain limited, especially if short pulse operation is desired. For example, in the case of higher gain media such as Nd:YAG, efficient single mode laser oscillation from a, 8-10 μm thin waveguide cannot be readily sustained at pump power inputs in excess of 20 W input due to parasitic oscillations and amplified stimulated emission (ASE) effects. Losses attributed to these effects represent even more of an issue for pulsed operation, where overly high gains may prevent Q-switch hold-off. In addition, for short pulse operation, waveguides with small cross-sectional areas may be subject to optical coatings' damage due to high intra-resonator peak powers.

Thus, an extension of the solid state waveguide technology to higher power requires utilization of thicker active cores so as to allow efficient pumping using more several diode bars, while providing for operation at acceptable gain levels. By doing so, the waveguide becomes multimode, requiring use of hybrid resonator designs to obtain high brightness. An interesting design approach to one such multimode slab waveguide was reported by Baker et al (see H. J. Baker et al in Opt. Comm. Vol 9, pp. 125-131, 2001) where a 200 μm Nd:YAG double-clad waveguide was used as the active material in a hybrid resonator, providing 270 W with M²<3.5×6. However, while Baker et al were able to capitalize on transverse mode discrimination similar to what was previously accomplished for CO₂ lasers, their approach suffers from several critical deficiencies. In particular, they implement a modified face-pumped approach which requires multi-passing of the pump radiation to assure efficient absorption even while imposing unfavorable trade-offs between pump absorption length and desired heat dissipation properties, leading to lower efficiencies and increased structural complexity of the pump chamber and cooling loops. Finally, even with 200 μm thickness, the gain for materials such as Nd:YAG is still too high for efficient pulsed operation at scaled-up powers because of ASE losses.

To date, short pulse operation from planar solid state waveguides or thin slabs operated in a Q-switched or mode-locked mode producing significant power outputs have not been demonstrated. Even in a CW mode, feasibility of power scaling to >100W at high repetition rates across a large range remains to be demonstrated, especially if high beam quality and reliable long term operation from efficient, cost-effective, manufacturable solid state structures are desired.

### SUMMARY

Accordingly, an object of the present invention is to provide diode pumped solid state laser systems, and their methods of use, with high output power from a single active laser component with minimal restrictions on the useable pump power range.

Another object of the present invention is to provide diode pumped solid state laser systems, and their methods of use, that provide improved beam brightness at scaled-up power levels by minimizing the effects of thermally-induced aberrations and stress birefringence.

A further object of the present invention is to provide diode pumped solid state laser systems, and their methods of use, that provide improved beam brightness at scaled-up power levels utilizing high aspect ratio planar gain element geometries.

A further object of the present invention is to provide diode pumped solid state laser systems, and their methods of use, that provide improved beam brightness at scaled-up power levels consistent with one dimensional heat flow perpendicular to a beam propagation direction across an entire width of the active region.

Yet another object of the present invention is to provide diode-pumped solid state laser systems, and their methods of use, that select mutually orthogonal directions for pumping, cooling and beam propagation.

Another object of the present invention is to provide diode-pumped solid state laser systems, and their methods of use, that use mutually orthogonal directions for pumping, cooling and beam propagation by use of a planar, thin slab gain medium

A further object of the present invention is to provide diode-pumped solid state laser systems, and their methods of use, using a thin slab laser that is edge-pumped and has cooling along the two largest opposing faces which are orthogonal to the pump direction and to the beam propagation direction Accordingly, an object of the present invention is to provide an optical system that has a high reflector and an output coupler which define a resonator cavity and an optical axis. A slab gain medium is positioned in the resonator cavity. The slab gain medium is configured to provide propagation of an optical laser beam along the optical axis through the slab medium. A first diode pump source produces a first pump beam incident on the slab gain medium in a direction perpendicular to the optical axis. A cooling member is coupled to the slab gain medium and provides cooling in a direction perpendicular to the optical axis and to the direction of the first pump beam.

In another embodiment of the present invention, a laser structure includes a high reflector and an output coupler that define a resonator cavity with an optical axis. A slab gain medium is positioned in the resonator cavity and has an aspect ratio greater than 5. The slab medium is configured to provide propagation of an optical laser beam along the optical axis through the slab medium. A cooling member is coupled to the slab gain medium. A first diode pump source produces a first pump beam incident on the slab gain medium in a direction perpendicular to the optical axis.

In another embodiment of the present invention, a laser structure includes a high reflector and an output coupler that define a resonator cavity with an optical axis. A slab gain medium is positioned in the resonator cavity. The slab gain medium includes top and bottom surfaces, first and second side surfaces and first and second end faces. A cooling member is coupled to the top and bottom surfaces. A first diode pump source produces a first pump beam incident on a full face of at least one of the first and second side surfaces. An optical beam propagates in the slab gain medium in a plane that is parallel to at least one of the top and bottom surfaces.

In another embodiment of the present invention, an optical system includes a high reflector and an output coupler that define a resonator cavity with an optical axis. A slab gain medium is positioned in the resonator cavity and has an aspect ratio less than 50. The slab medium is configured to provide propagation of an optical laser beam along the optical axis through the slab medium. A cooling member is coupled to the slab gain medium. A first diode pump source produces a first pump beam incident on the slab gain medium in a direction perpendicular to the optical axis.

In another embodiment of the present invention, an optical system includes a slab gain medium positioned along an optical axis and has an aspect ratio greater than 5. The slab gain medium is configured to provide propagation of an optical laser beam along the optical axis through the slab medium. A first diode pump source produces a first pump beam incident on the slab gain medium in a direction perpendicular to the optical axis. A cooling member is coupled to the slab gain medium and provides cooling in a direction perpendicular to the optical axis and to the direction of the first pump beam.

In another embodiment of the present invention, a method is provided for producing a high quality beam from a diode pumped solid state laser at high power. The high quality beam propagates an optical beam through a slab gain medium. An optical system is provided that is coupled to the slab gain medium that provides pumping, cooling and extraction of an optical beam along axes that are mutually orthogonal. An output beam is produced with a power of at least 80 W.

In another embodiment of the present invention, a method is provided for producing a high quality beam from a diode pumped solid state laser at high power. An optical system is provided with a slab gain medium that has a depth, length and a width, The width is selected to maximize absorption from a pumping radiation and the depth is selected to provide a one-dimensional thermal profile. The optical beam propagates through the slab gain medium. A beam is produced with a power of at least 80 W

In another embodiment of the present invention, an optical system includes a slab gain medium positioned in the resonator cavity. The slab gain medium is configured to provide propagation of an optical laser beam along the optical axis through the slab medium. A first diode pump source produces a first pump beam incident on the slab gain medium in a direction perpendicular to the optical axis. A cooling member is coupled to the slab gain medium and providing cooling in a direction perpendicular to the optical axis and to the direction of the first pump beam.

### BRIEF DESCRIPTION OF THE DRAWINGS

FIG. 1 depicts the thin slab geometry with mutually orthogonal cooling, pumping and beam propagation directions.

FIG. 2 is a schematic diagram of one embodiment of a laser oscillator of the present invention that includes a diode-pumped thin slab

FIG. 3 is a cross-sectional view of one embodiment of an edge-pumped, face-cooled thin slab laser of the present invention.

FIG. 4 is a three-dimensional representation of a slab mechanical mounting structure that can be utilized with the present invention.

FIG. 5 illustrates in greater detail the FIG. 4 mechanical support structure.

FIG. 6 is a close-up view of a face-coated thin slab that can be utilized with the present invention.

FIG. 7 is a illustrates of one embodiment of a composite slab, with the active material sandwiched between two other slab-shaped stacks made of a different material, that can be utilized with the present invention.

FIG. 8 is a diagram that illustrates a more complex, 5-layer slab composite that can be utilized with the present invention.

FIG. 9 is a schematic diagram of one embodiment of a stable resonator that incorporates a slab that can be utilized with the present invention.

FIG. 10 shows a plot of the multimode power output of a 0.7 mm thick 0.8% Nd:YAG slab

FIG. 11 shows a plot of the multimode performance of 1.0 mm thick, 0.8% Nd:YAG slab

FIG. 12 illustrates one embodiment of a hybrid resonator with a thin slab of the present invention.

FIG. 13 shows the output power performance of a 0.7 mm thick slab in the FIG. 12 hybrid resonator.

FIG. 14 shows the output power from the 0.7 mm slab of FIG. 13 as a function of hybrid cavity length

FIG. 15 is a plot of a projected beam propagation parameter, of one embodiment of the present invention, as a function of pump power for an optimized hybrid resonator design.

FIG. 16 is a schematic diagram that illustrates two types of off-axis hybrid resonators including a slab-shaped laser material of the present invention.

FIG. 17 illustrates the Q-switched output from a Q-switched hybrid resonator embodiment of the present invention with a 1 mm thick slab.

### DETAILED DESCRIPTION OF THE PREFERRED EMBODIMENTS

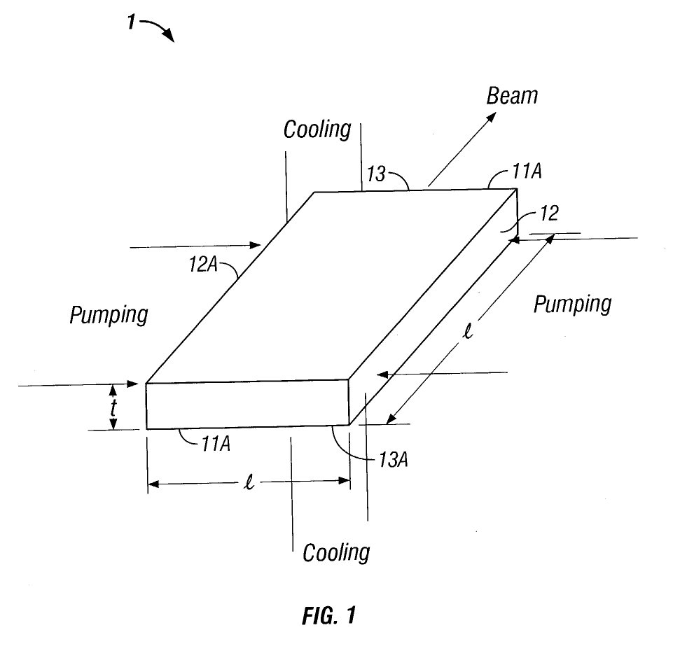

In various embodiments, the present invention provides an active gain medium configured as a thin slab laser edge-pumped by radiation from diode arrays with cooling provided along the two largest opposing faces, which are orthogonal to the pump direction and also to the beam propagation direction FIG. 1 illustrates the basic thin slab geometry configured according to the principles of the invention as a slab 1 of width w, thickness t and length l, with the pumping, cooling and beam propagation directions indicated as all mutually orthogonal along Cartesian coordinates x, y and z, respectively. The slab's cross-section is defined by a pair of opposing end-faces 11 and 11A through which the laser beam propagates. It is preferably pumped through narrow elongated edge-faces 12 and 12A and cooled through the broader top and bottom surfaces 13 and 13A. It is a key aspect of the present invention that the slab possess a high aspect ratio (defined as w/t) as well as thickness t small enough to allow efficient heat dissipation along the y direction through the top and bottom lateral faces 13 and 13A, preferably by contact with solid cooling blocks made of material of high thermal conductivity. The pump radiation is preferably provided by diode arrays, which may be constructed as stacks of bars or be fiber coupled directly to the slab. The slab may be placed in a resonator or it may serve as an amplifier for a signal beam. In either case, the optical axis of the system coincides with the beam propagation direction z shown in FIG. 1. With this novel construction, the different dimensions of the slab can be optimized separately to provide efficient, power scalable, high brightness performance. For example, the width w of the slab may be selected to maximize pump absorption, while the thickness t is chosen to provide optimal aspect ratio w/t consistent with gain constraints. As will be elaborated below, gain for a slab configuration is an especially important consideration for short pulse operation because of the increased potential for parasitics and ASE losses. Having thus selected the width and thickness, the laser designer is then free to select the length l of the slab to provide the desired power level by stacking diode bars (which may or may not be fiber-coupled) along this dimension. Power therefore scales with the slab length l for given slab aspect ratio and pump absorption parameters.

The active slab material consists of a gain medium, such as Nd:YAG, which may be coated, bonded or brazed to different materials along its larger faces, prior to contact with the cooling blocks. Embodiments addressed in the present invention include straight-through thin slabs of high aspect ratio or, in the case of low gain materials, weakly-guiding multimode slab structures.

In various embodiments of the present invention, thin slabs with aspect ratio greater than 5 are found to be best suited for maintaining uniform mechanical stress, birefringence and thermal lensing properties of the active element. The selection of the slab thickness is motivated by the need, on the one hand, to make it sufficiently small for efficient, one-dimensional heat transfer to the surrounding cooling structure and on the other hand, sufficiently large to provide efficient coupling to the pump and/or limiting the gain to thereby avoid undesirable ASE and parasitic losses. Thus, slabs with aspect ratios that are greater than 5 but smaller than about 20 are most beneficially utilized for higher gain, high conducting media such as Nd:YAG. For very high gain materials such as Nd:YVO₄ larger thickness—preferably over 1 mm—may be necessary to avoid ASE losses, which can, in this case, limit the aspect ratio to less than about 10. Alternatively, for lower gain crystalline materials such as Yb:YAG, thinner slabs and higher aspect ratios (preferably >10-20) are preferably selected, including slabs that are thin enough to weakly guide the signal radiation. In any of the above embodiments the slab may be uncoated or it may be coated or sandwiched between suitably matched dielectric materials to provide some reflection of the pump light.

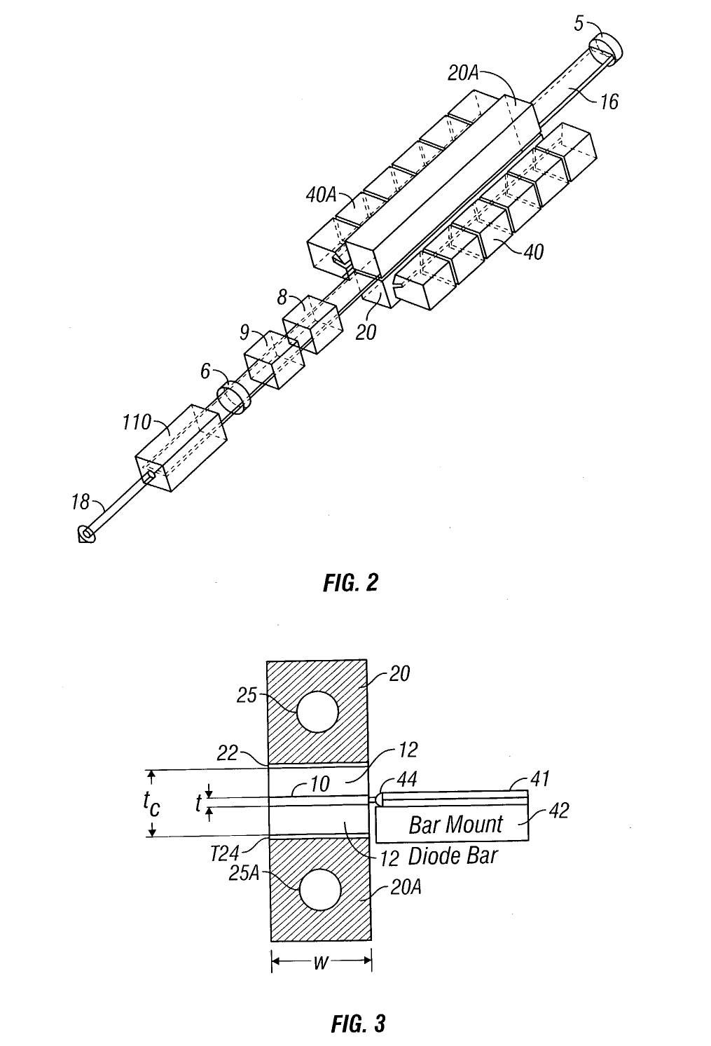

FIG. 2 illustrates schematically the diode-pumped slab laser resonator 11 formed in accordance with concepts of the subject invention. The resonator is defined by at least a high reflector 5 and an output coupler 6. A modulator 8 may further be incorporated within the resonator, which may be a Q-switch or mode locker. Other optics such as polarizers, apertures etc. may be included within the cavity as required and are generically represented as optical element 9. Optical beam shaping elements, collectively indicated as composite 4, may be placed outside the resonator. The gain medium 10 includes one or more slab sections including optically active and inactive solid state materials all configured in the shape of an elongated rectangular slab as was shown in FIG. 1. As defined herein, the longitudinal or optical axis 15 of the resonator 11 is parallel to the plane of the laser radiation 16 formed between the oscillator mirrors 5 and 6, upon excitation of the active gain material comprising the slab. The laser beam 16, defined by the resonator is generally rectangular in shape with an aspect ratio approximating that of the slab cross-section. Special beam transformation optics 110 may be utilized external to the resonator to symmetrize the beam, converting it to near-circularly shaped output beam 18.

Pump radiation from an emission line of semiconductor diode laser arrays, collectively indicated as 40 and 40A, is allowed to enter the slab through the slab's edge faces indicated as 12 and 12A, respectively, in FIG. 1. In the preferred embodiment the pump is arrayed as a plurality of stacked diode bars, located in close proximity to the slab's edges. Each array comprises multiple diode lasers. In the arrangement depicted in FIG. 2, six stacks are shown on each side, but more or fewer stacks may be used depending on output power requirements. The diode stacks may be supplied by a commercial vendor such as Spectra-Physics Semiconductor lasers (SPSL) and CW power outputs of 50 W per bar are now readily available with emission wavelengths centered anywhere between 802 and 810 nm bands commonly utilized for Neodymium-doped materials such as Nd:YAG. The selection of the center pumping wavelength is critical to establishing a uniform gain profile for a given width of the slab, as will be described further below. In certain cases, quasi-CW diode sources may be used, depending on the gain material excitation band parameters. For high power applications, pumping from two sides, using two sets of diode array stacks arrayed along the length of the slab is utilized, as illustrated in the embodiment of FIG. 2. Alternatively, pumping from only one side may be employed with or without a reflective coating deposited on the opposite edge of the slab for pump light back reflection. Such one sided pumping may be well adapted to strongly absorbing laser materials, to slabs with shorter widths and/or to lower power applications.

FIG. 3 illustrates a cross-sectional view of the preferred embodiment of the edge-pumped slab laser. The diode laser 41 is shown mounted on bar 42. Embodiments using either lensed or unlensed bars (i.e., with and without lenses 44) fall within the scope of the present invention, depending on the slab structure and desired operational parameters. In the preferred embodiment the diode light is collimated along the fast direction using cylindrical microlenses, collectively indicated as 44. Unlensed bars are known to provide highly divergent light—typically over 10×60 degrees at the 85% intensity points. Lensed arrays may be provided by semiconductor laser vendors as a common option to standard products. As is known in the art, microlenses generally reduce the divergence of the fast axis of the bars to less than approximately 2 degrees while the slow axis retains a full angle divergence on the order of about 10 degrees (all at the 85% intensity points). High coupling efficiency is achieved for pump light traversing straight through the slab, as long as the active slab thickness is greater than the corresponding spatial extent of the collimated diode light. No guiding of pump radiation is required in this case and slabs of the active material with only frosted or polished faces are sufficient for efficient operation of the laser, without any particular cladding, making this embodiment a readily manufacturable, cost effective option.

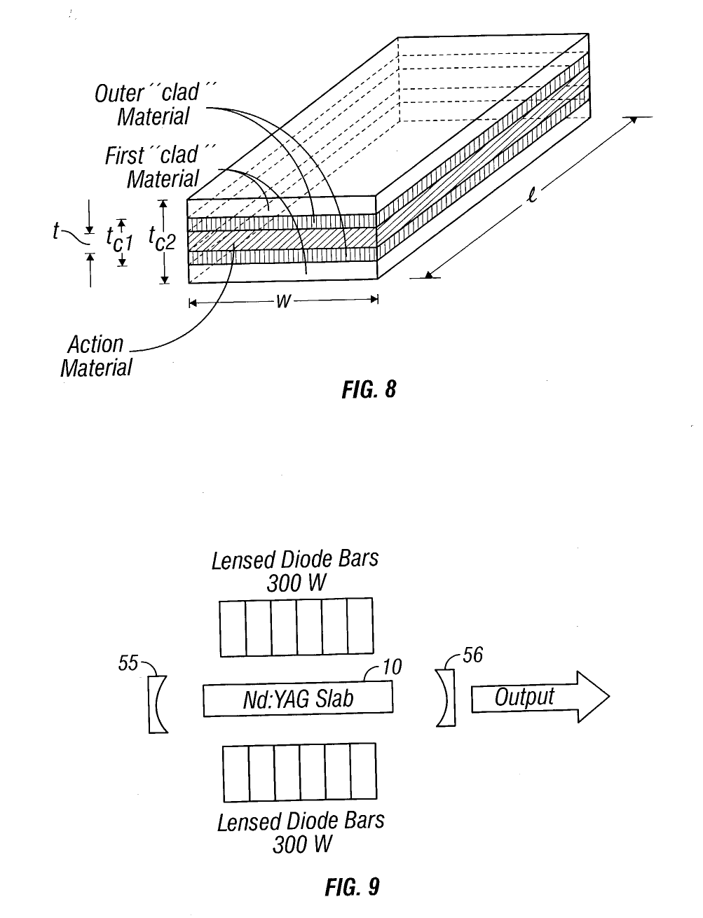

In alternative embodiments, radiation from unlensed diode bars is utilized to pump the slab. To assure high pumping efficiency in this case, it may ne beneficial, under certain conditions to use composite slabs, based, for example, on various bonded structures as discussed further below in connection with FIGS. 7 and 8. Such structures generally possess higher numerical aperture than the bare active slab with its relatively small thickness may provide, and may further partially or completely guide the pump radiation, thereby increasing the efficiency of coupling of divergent pump radiation to the active material. For illustration purposes, such a composite slab is shown in FIG. 3, where active material 50 of thickness t is contacted to slabs 51 and 51A comprising undoped material of lower index of refraction, for a total slab thickness t_{c}. Alternative embodiments of slab 10 may consist of uncoated, coated, or any other kind of composite slab, all of which share the property of high aspect ratio, and high pump light coupling efficiency for the active material portion of the slab.

In still another alternative embodiment, light may be coupled to slab 10 using an optical fiber bundle, as is known in the art of diode end-pumped lasers(see for example U.S. Pat. No. 5,436,990 which teaches methods for coupling a multiple emitter laser diode bar to an optical fiber). In the case of the slab, the optical fiber bundle may consist of a linear fiber array termination at each end of the fiber. At the diode light input end, the fibers in the linear array would have a lateral spacing corresponding to the laser diode emitter spacing, thereby allowing each emitter to be directly coupled into its corresponding fiber. At the fiber bundle output end, where the laser diode light is coupled into the slab laser gain medium along its length, lateral fiber spacings may be selected depending on pump light distribution requirements, and these may or may not differ from the fiber spacings at the input end of the fiber bundle.

The slab 10 (which may be coated or multi-sectioned composite as alluded to above) is thermally controlled by contacting its top and bottom surfaces to cooling blocks 20 and 20A using thin interface layers 22 and 22A shown in FIG. 3. The cooling blocks act as heat sinks, cooling the slab by drawing heat away from the faces according to known principles of direct conduction cooling. Efficient heat transfer from the pumped medium to the heat sinks is critical for establishing the desirable one dimensional temperature gradient within the lasing medium. The thermal interface layers placed between the slab surface (which may or may not be coated) and the heat sink help minimize thermal resistance at the interface, and also eliminate complications due to potential contamination of optical surfaces due to, for example, outgassing. For the interface layers to provide an efficient thermal contact between the slab surface and the cooling blocks generally requires that the layers be thin and be able to conduct heat efficiently. It is further preferred that the thermal contact layers 22 and 22A be relatively soft compared to the cooling blocks so as to allow them to conform to any irregularities in the mounting heat sinks or the slab's surfaces.

This permits thermal contact layers 22 and 22A to act as flexible buffer layers, to help absorb thermal stress between the slab and the heat sink. Suitable materials for thermal contact layers include gold, indium and copper. These materials are available as thin foils, are sufficiently compliant and have thermal conductance that can compensate for variations in thermal conductivities between the slab (or the material that comprises the top and bottom surfaces of a slab composite) and the cooling block. Gold may be preferred material in embodiments where the thermal contact layer is also required to be especially thin and/or provide high pump light reflection, since gold has the added feature of efficient reflection at almost any wavelength. On the other hand, indium has several other advantages including a lower melting temperature (about 157 degrees compared to over 1000 degrees for gold) and is sufficiently soft to act as an excellent buffer layer.

Indium may be used both as a cold contact layer or it may be used as a solder for bonding the slab to the heat sinks, a process usually carried out during assembly, wherein the cooling block/indium/slab assembly is held under pressure at elevated temperatures to flow the indium and eliminate contact resistance. Such bonding or “brazing” process is known in the art as an effective means for compensating for thermal expansion differences between crystalline or glass laser material and the material it is soldered to.

More complex composite structures may alternatively be implemented to further reduce the stresses caused by thermal expansion differentials between a long and thin slab and the metallic cooling blocks. In one preferred embodiment, an thin alumina strip of the same surface dimensions as the slab may be sandwiched between two thin layers of indium, used to as buffer thermal contact to the slab on one side and the cooling thermal block on the opposing side. Since alumina and slabs made of crystalline materials (such as Nd:YAG) have comparable thermal expansion coefficients, there is minimal stress build-up along this critical interface. Still other alternatives, such as other types of ceramics or copper mesh filled with transition metal material may be considered, all of which fall within the scope of the present invention.

Preferably cooling blocks 20 and 20A are fabricated of a metal with high thermal conductivity such as copper or aluminum alloy, and are generally of identical construction to help maintain symmetrical heat distribution. According to one aspect of the invention, the cooling blocks are mounted on the broad surface of the slab and are of sufficient width to control the heat flow from the active area. Thermal modeling shows that to achieve a one dimensional heat flow across the thickness of the slab, the width of the cold plates should be equal to the width of the slab. To assure adequate thermal transfer rates during operation, coolant flow channels 25 and 25A are provided within the cold plates structure to allow water or other fluid to be pumped through. At least one such flow channels may be provided per each coolant block.

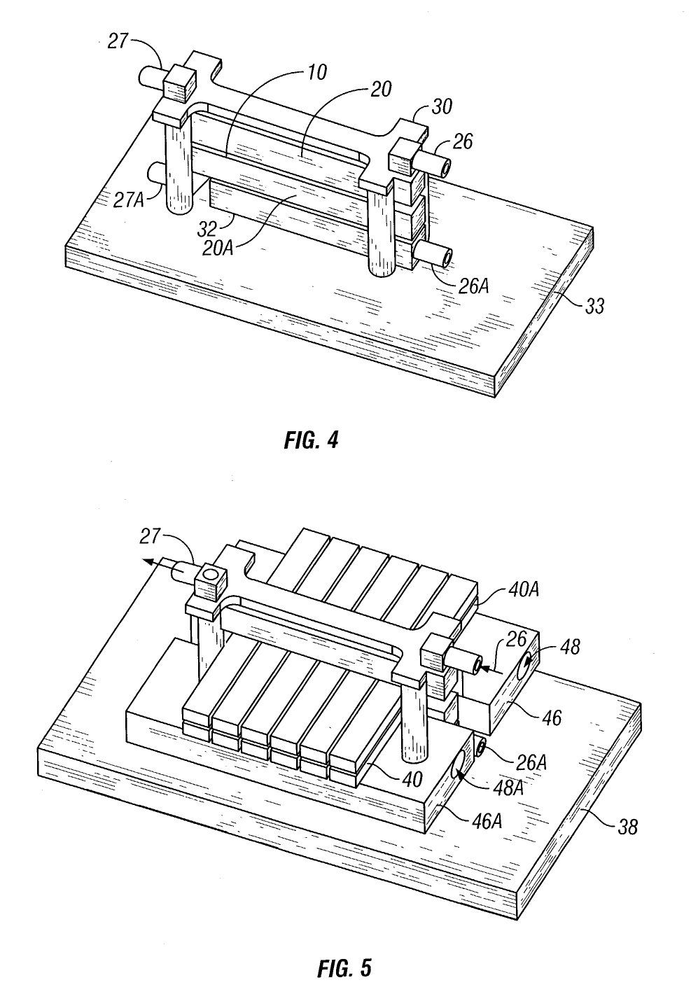

A three dimensional representation of the mechanical mounting structure for the slab is shown in FIG. 4. Indicated are clamps 30, support structure 32 and base 33 as well as cooling blocks 20 and 20A which are shown here as extending some distance beyond the length of slab 10. Annular water inlets 26 and 26A and outlets 27 and 27A provide the conduit to water flow channels 25 and 25A.

FIG. 5 shows further detail of the mechanical support structure along with the mounted diode stacks 40 and 40A, diode stack support structures 46 and 46A and the diode array cooling inlets 48 and 48A.

Although only one cooling channel for each cooling block were shown in FIGS. 3, 4 and 4A, it is to be understood that more sophisticated designs involving two or more cooling channels fall within the scope of the present invention. FIG. 5 shows an example of a cooling scheme based on counter-flow using two inlets per block. The flow direction indicated in FIG. 5 is in series but parallel flow is also feasible. Such additional cooling paths have the advantage of providing better temperature averaging across the block and may be especially useful at high powers, by affording better, more symmetric cooling and preventing the slab from flexing. As still another alternative, microchannel interfaces may be incorporated for still superior thermal cooling uniformity.

It is noted that the type of an edge pumped thin slab laser that is pumped and cooled according to the principles of present invention, has a number of key advantages over many prior art slab lasers. For example, since the pumping faces are distinct from the cooled faces, an efficient passive cooling system can be readily designed separately from the pumping system. Passive conductive cooling comprising two cooled solid heat sinks as described above is easy to engineer at an acceptable cost. While this aspect has been discussed before in reference to U.S. Pat. No. 6,134,258, the present invention differs in a number of significant aspects from this prior art. In particular, the present invention provides for straight through propagation of the laser beam through the slab and does not rely on zigzag path. Deleterious thermal lensing and stress birefringent effects caused by temperature induced variations in the index of refraction are minimized by virtue of favorable heat dissipation properties afforded by the high aspect ratio of the slab, without requiring the high degree of face polishing required for more complex beam paths. The novelty of designs included in this invention allow the direction of heat flow—and therefore the temperature gradient—to be perpendicular to the plane of propagation of the laser beam, without placing any stringent on the slab surface parallelism and polish quality. Since the beam path is orthogonal to the heat flow, the thin, high aspect ratio slab laser displays far less sensitivity to cooling nonuniformities, distributes mechanical stress better and is less susceptible to warping as compared with the device of the above referenced patent as well as other slabs of the prior art.

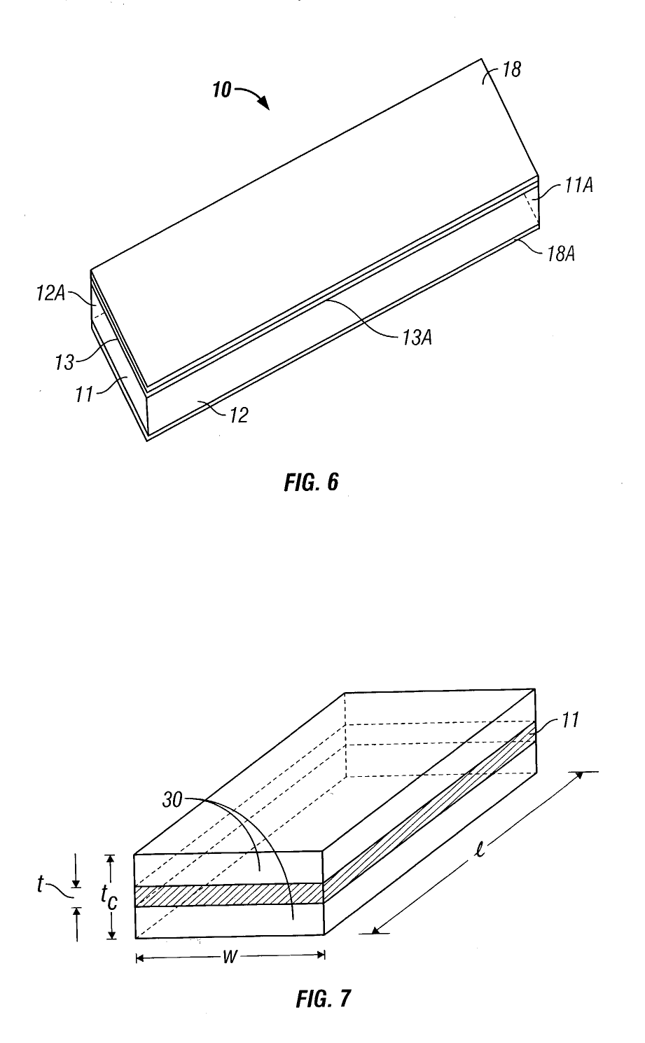

The key issues in providing efficient operation from an edge-pumped thin slab involve coupling of the pump light. FIG. 6 shows an embodiment 110 of slab 10 wherein the top faces 13 and 13A are coated with suitable reflecting layers 18 and 18A such that the pump light may be guided inside the slab through periodic reflections off these coated faces. Pump input faces 12 and 12A are anti-reflection (AR) coated at the pump wavelength, while end-faces 11 and 11A are AR-coated for the lasing wavelength, as is customary in the art. The pairs of faces 11 and 11A, 12 and 12A and 13 and 13A are generally parallel but may include a slight wedge to suppress undesirable parasitics. In this embodiment, only the end faces of the slab must be polished to high optical grade (typically, about λ/10).

The generic slab shown in FIG. 6 may consist of any one of known solid state gain materials, including but not limited to garnets, fluoride and oxide crystals doped with rare-earth ions such as Nd, Tm, Er, Ho, Pr and Tm. Preparation of said coated slab proceeds through the steps of polishing the large upper and lower sides of the slab and then coating them with a material (dielectric or metallic) that is highly reflective at the pump wavelength. The coatings may be applied by standard techniques, such as ion sputtering, and coating material may be selected without regard to its reflection properties at the lasing wavelengths. This is because the slab thickness, although small compared with other slabs of the prior art, generally still exceeds the dimensions required for guiding the signal. Assuring homogeneity of pump absorption for a given divergence of the light from the diodes is however a an important criterion affecting the choice of coating material and surface finish. Random, non-directional pump light scattering may, for example, cause insufficient absorption at the center of the slab, translating to high losses. Furthermore, care must be taken to avoid spurious reflections of the amplified laser beam to avoid significant levels of parasitics and amplified spontaneous emission (ASE). There are indications that the indium foil used as a contact thermal layer to interface to the heat sink may, in itself, serve as an adequate reflecting layer, providing sufficient pump light reflection, yet without contributing to parasitics. Therefore, according to one aspect of this embodiment, the coatings 18 and 18A are identical with the thermal contact layers 22 and 22A shown in FIG. 3. In this case, it is only necessary to polish slab surfaces 13 and 13A to standard 20/10 optical grade, or they may be frosted to allow better adhesion of selected coatings.

As was already noted above, although some pump light guiding may be desirable if divergent light from the diode stacks is directly coupled into the slab, this may not be necessary when diode light from lensed diode arrays can be propagated straight through the width of the slab without reflecting off the surfaces. Therefore, according to another key aspect of the invention, the minimum thickness dimension of the slab may be selected to match the numerical aperture and lateral dimension of the pump beam such that the pump light remains spatially confined inside the gain material with minimal spreading upon passage through the entire absorption length.

Because the width dimension of the slab is generally dictated by pump light absorption considerations, the unguided configuration may impose some constraints on the aspect ratio that need to be taken into account. Homogeneous pump absorption may therefore require a trade-off against thermal considerations, which dictate a minimum aspect ratio for a given desired power level. The minimum aspect ratio as well as the slab thickness can generally be derived according to known scaling laws, which govern thermal dissipation in solid media. Preferably, aspect ratios greater than about 5 are consistent with a near-one dimensional thermal gradient, for media such as Nd:YAG, which has high thermal conductivity. Thermal modeling indicates that for solid state gain materials with thermal conductivities and expansion coefficients similar to those of YAG, as long as the aspect ratio of the slab is greater than about 5, the temperature across the slab's thickness increases by only a few degrees Celsius. For other materials with lower thermal conductivity such as glass, larger aspect ratios may be required (i.e., thinner and wider slabs) and/or more cooling channels have to be provided to accelerate the thermal transfer rate into the heat sinks.

Uniformity of the pump absorption profile is another important consideration for optimal operation of a laser containing the thin slab of the present invention. In particular, the pump wavelength and the doping concentration of the active material must be selected so as to avoid over-inversion at the edge of the slab and under-inversion at the center. Therefore, under certain conditions, the optimal pump wavelength may be selected at an off-set from the center of the gain medium absorption peak. In this case, the width of the slab may need to be increased as well, to assure complete absorption of the pump light. The resulting increase of the aspect ratio is not, however, expected to be detrimental to the overall operation of the slab laser, as heat removal properties will only be enhanced.

Many other configurations that may provide a measure of pump light guiding may be envisioned and a number of them have already been successfully tested. One attractive alternative involves total internal reflection (TIR) of divergent pump light from an interface involving a change in the index of refraction. In one such embodiment, composite slab 120 is constructed by placing active slab material 50 between two dielectric slabs 51 possessing lower index of refraction than doped active material 50, as illustrated schematically in FIG. 7. This is similar to the clad structure shown as an example in FIG. 3 above.

One suitable material for the outer two dielectric slabs is sapphire which has the additional beneficial property of high thermal conductivity and may therefore serve also as an intermediate heat sink for the slab. Outer slabs 51 may be joined to the active slab 50 using an adhesive, a thermal contact layer such as indium, or it may be optically bonded without adhesive. A particularly successful application of the later method that was demonstrated in a wide variety of solid state materials involves the approach of adhesive-free bonding, (AFB) as disclosed by Meissner in U.S. Pat. No. 5,846,638. This technology was successfully used to demonstrate numerous composite structures of doped and undoped solid state media. Slabs of different bonded materials, prepared according to this method are commercially available from Onyx, Inc.

For example, Nd:YAG as the active material, can be bonded to sapphire as the outer slabs, using this method. This provides a numerical aperture of greater than 0.45, which is sufficient to intercept the diverging pump light from unlensed diodes with reasonable coupling efficiency. The three-slab sandwich can then be efficiently edge-pumped by lensed or unlensed diode bars as long as the slab thickness is sufficiently large to intercept most of the diode light. For unlensed bars, long absorption paths and high absorption efficiency may be are achieved since the pump light is guided through total internal reflection from the outer slab interfaces. On the other hand, efficient pump coupling may require placement of the unlensed diode stacks in close proximity to the slab, which may not always be mechanically feasible. Alternatively, lensed bars may be used to advantage with this configuration, with slab thickness selected to closely match the incident pump light spatial dimension. Requirements on materials and interfaces with the outer slabs may be relaxed in this case, although it is recognized that composite slabs may still be instrumental in providing more homogeneous distribution of the pump light—a desirable property for assuring a high beam quality output.

In still another embodiment, the active slab material 60 is placed between two stacks, each of which is comprised of two slabs of different dielectric materials as shown in FIG. 8. The composite slab 130 comprises the active material 60 bonded or interfaced with inner slabs 61, which may comprise, for example, dielectric materials with a lower refractive index compared to the index of the active slab 60, while the outer slabs 62 have a lower index of refraction relative to the inner slabs at the pump wavelength. This “double-clad” configuration has the advantage of reducing the sensitivity to position variations of pump light from the diode stacks. In addition, the index differences between the active material and the first stack may be selected to guide the signal while the second stack will guide the pump beam. In a preferred embodiment the material of the two slabs that are in contact with the center slab are again of the same material as the center slab, but have a different doping concentration or are undoped. Composite slabs of multiple different materials prepared in a “double clad” configuration according to the method of Adhesive-free Bonding are commercially available from Onyx, Inc. These structures were already used successfully to provide laser output from slabs configured as single mode waveguides, as taught by Meissner in U.S. Pat. No. 6,160,824.

It will be appreciated however, that by contrast with the prior art teachings of Meissner, active slabs of the present invention, are not dimensioned for single mode operation, as the slab thickness generally exceeds the required single mode dimension (typically only 10-20 μm for Nd and Yb-doped crystals) by more than an order-of-magnitude. For example, in the case of high gain materials, such as Nd:YAG, slab thickness selected according to principles of the present invention may range from several 10's of microns to over 1000 μm, depending on specific material figure-of-merit parameter, incident pump power and required output powers and mode of operation.

Thus a suitable figure-of-merit is selected with due regard to fracture limits and attainable small signal gains prior to onset of ASE for pulsed operation. Our analysis indicates that for pump powers in excess of 100 W, resonator configurations may be optimized without regard to losses due to the effects of ASE and parasitics as long as the small signal gain factor is preferably less than about 5. For Nd:YAG, this implies slab thickness that is greater than 0.5 mm, which is almost two orders of magnitude more than the waveguide structures described in U.S. Pat. No. 6,160,824. In general, for lower gain materials such as Yb:YAG, Er:YAG Tm, Er or Pr-doped fluoride crystals or doped glasses, thinner slabs may be used with or without outer slab claddings or bonded stacks, but the thickness in all cases still exceeds the single mode dimension.

It is further noted, that even the composite slabs prepared according to the “clad” configurations shown in FIGS. 7 and 8 above rely, in preferred embodiments, on free space, rather than guided signal propagation in all directions. In alternative embodiments, where the active center slab is thin enough to provide weak guidance of the signal, such waveguiding will be highly multimode in nature, leading to multimode laser output. In such cases, a multimode waveguide may still achieve single mode operation using coated slabs according to FIG. 6 whereby metallic or dielectric coatings are selected to allow maximum discrimination against higher order waveguide modes.

The principles of such multi-mode waveguide operation were well analyzed and the performance validated for CO₂ lasers, but not for solid state lasers. Since mode discrimination is proportional to the factor λ²/t³ where λ is the emission wavelength and t the waveguide thickness, coated waveguides may be especially advantageous for active media emitting at longer wavelengths. In this case, a single transverse mode may be extracted from waveguides that are not overly thin, and are therefore readily manufacturable. For example, in the case of erbium doped crystals with emission near 3 μm, a 500-700 μm thick waveguide slab may provide near single mode performance equivalent to that obtained from well-established 1.5 mm thick CO₂ waveguide slab lasers, using similar hybrid resonator constructions. This cross section should improve the performance from many low gain Erbium (Er) or holmium (Ho) doped materials, yet it is large enough to allow application of suitable metal or dielectric coatings with standard techniques. Note that even for a 1 μm emitting material such as Yb:YAG, coated waveguides 300-400 μm thick, should be thin enough to promote lower order mode operation, again by analogy with CO₂ waveguide slab lasers. The selection of thickness for such waveguide slabs will depend on trade-offs between the gain (which limits Q-switched operation) and desired spatial mode properties.

As was shown in FIG. 2, the active laser component is placed inside a resonator, said resonator incorporating at least two mirrors. The laser may be operated in a CW mode, or alternatively, in a pulsed mode using a modulating device, such as an AO or EO Q-switch. Different resonators can be designed to provide either a spatially multimode output beam with M² values between 1.5 and 50 or a near diffraction limited output beam with M²<1.5.

For example, the active slab can be disposed within a hybrid resonator so as to reduce the beam divergence in the unstable direction while operating in a low order mode in the stable direction. Such hybrid resonators are known in the art of CO₂ slab waveguide laser designs and have recently been successfully implemented with solid state lasers as well. Therefore, such hybrid resonator constructions comprising an unstable resonator in the wider dimension and guided, stable or unstable resonator in the orthogonal, thin direction as are available in the art are all incorporated by reference herein.

The high power, diode-pumped lasers constructed with the thin, edge-pumped slab configurations of the invention preferably provide output powers in excess of 100 W in near-single transverse mode and over 200 W for multimode operation in either CW or Q-switched mode, all with high degree of stability for extended periods of time. The operational mode is selected by placing the appropriately dimensioned thin-slab shaped gain material along with the appropriate optical devices and elements inside the laser resonator.

One consequence of the high aspect ratio of the active slab is that the laser beam emerging from the slab resonator generally has rectangular shaped cross section which is highly astigmatic. It is, however, well known in the art of optical design that with specially designed optics, astigmatic laser beams can be converted into rotationally symmetric beams. In one preferred embodiment, the element 6 indicated in FIG. 1 external to the resonator, consists of a bifocal telescope in conjunction with a mode converter. The telescope serves to equalize the Rayleigh lengths and waist positions in the x- and y-directions of the original astigmatic laser beam. Symmetrization is achieved by passing the beam through a transformation optics, consisting in a preferred embodiment of several cylindrical lenses, selected according to known principles of optics design. The symmetrized beam output, shown as beam 18 in FIG. 1, has equal beam radii, far-field divergences and waist positions in the x- and y-directions. A hybrid resonators may be implemented in conjunction with optical techniques for beam symmetrization or circularization to provide for spatially round output beam that has high beam quality in both the stable and unstable directions.

The following are some examples of resonators designed and fabricated to test the operation of a laser built according to principles of this invention.

In one embodiment, illustrated in FIG. 9, a stable resonator is provided consisting of the active slab, a convex high reflectivity (HR) mirror 55 and convex outcoupler 56. Several types of slab structures were used in experiments designed to test the effectiveness of different pump coupling techniques and slab fabrication methods in the simple resonator of FIG. 9. In the first example, a composite slab structurally similar to the configuration shown in FIG. 7 was utilized. The active material selected was 0.8% Nd-doped YAG with the following dimensions: t=0.7 mm, w=10 mm and l=90 mm. The slab laser was contact bonded to a sapphire slab on one side and soldered with indium to another sapphire block on the other side. Both sapphire blocks were 1 mm thick with widths and lengths specified to match the Nd:YAG. The slab was specified All the slabs were 10 mm wide and 90 mm long. Thin indium layer was used to contact the outer faces of the sapphire blocks to the copper blocks used as heat sinks according to the embodiments shown in FIGS. 3-4. The active material was pumped by two stacks six 50 W diode bars from each side as shown in FIG. 9.

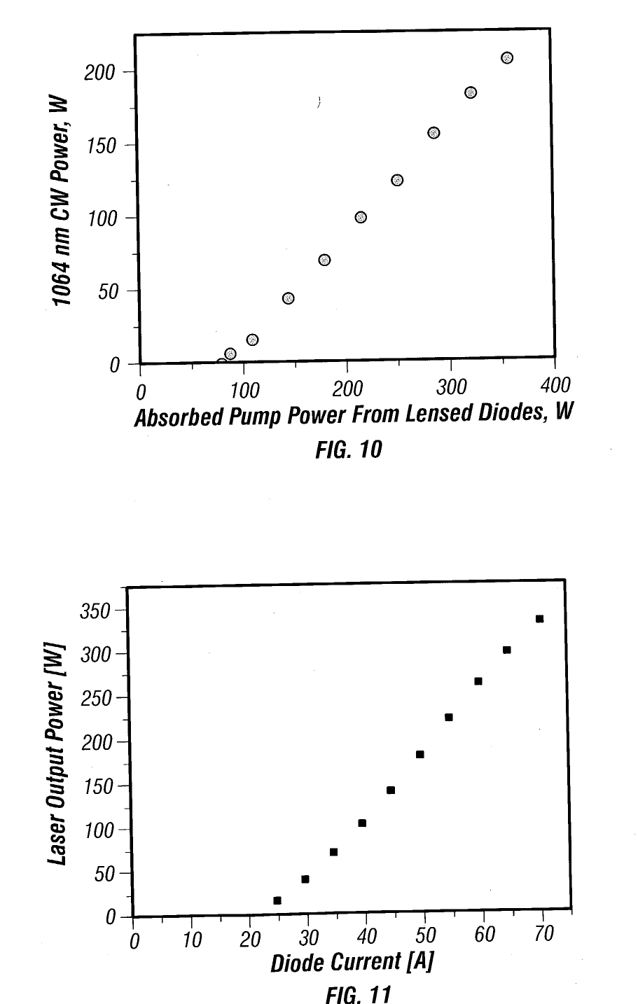

The dimensions of the composite slab provided a numerical aperture of 0.46, which was sufficient to couple a substantial portion of the pump radiation from the diode bars. In the first set of experiments, the diode bars were lensed, providing a collimated light with a diameter of 0.8 mm-20% larger than the thickness of the slab. FIG. 10 shows the output versus absorbed input power for 4 m curvature HR mirror and 2 m curvature, 50% output coupler. The cavity length for these experiments was set at 135 mm. As FIG. 10 shows, over 60% slope efficiencies are obtained from this cavity, indicating the robustness of the basic pumping and cooling approach used.

In another set of experiments, an 0.85 mm thick Nd:YAG slab was tested in the same cavity. The doping, width and length of the slab were the same as in the experiments described above, but no sapphire cladding or outer slabs were utilized. By pumping the slab with the lensed diode stacks, over 340 W were obtained for 700 W maximum pump power input (corresponding to diode currents of 70 Amp) without saturation, as shown in FIG. 11. This corresponds to over 40% efficiency. Clearly, this is taken as validation of feasibility of efficient edge pumping a thin slab using commercially available diode bar arrays.

A composite slab structure with the same 1 mm slab was also constructed using a ceramic intralayer and indium solder to contact with the slab and copper cooling blocks. With this “ ”brazed” structure, multi-mode output power of over 350W was achieved for 660 W input power input. The increased power is a result of uniform stress provided by the composite slab structure.

In one embodiment, the slab gain medium is placed within a hybrid resonator, consisting of an unstable resonator along the two larger slab sides that are perpendicular to the optical axis and a stable resonator along the two smaller slab sides. In order to adapt the mode sizes along these to the slab dimensions, cylindrical resonator mirrors may be used. An output coupler with a graded reflectivity profile may further be used to improve the beam quality. In the orthogonal direction, a stable or flat-flat resonator may be sufficient to achieve good beam quality provided the thickness t of the medium is selected so as to generate a low Fresnel number, typically less than about 5. For single transverse mode operation, the Gaussian beam diameter in the slab, 2a, is preferably adjusted relative to the thickness of the slab according to the relation t/2<2a<3t/2. In accordance with the subject invention, the mirror separation, proximity to the waveguide and radii of curvature are selected based on desired output coupling, overall beam quality and required stability and physical size constraints, using customary resonator design selection criteria [1,2]. Either positive branch or negative branch resonator may be implemented, depending on gain material and resonator parameters.

The output coupler defines a variable reflectivity mirror (VRM) known from the art of unstable resonators design. A VRM exhibits a supergaussian reflectivity profile conventionally expressed as:

R(x)=R₀ exp {−2(x/w)ⁿ}

Where R₀ is the center reflectivity, w is the profile radius, n is the super-gaussian index and x is the coordinate along the wide slab dimension.

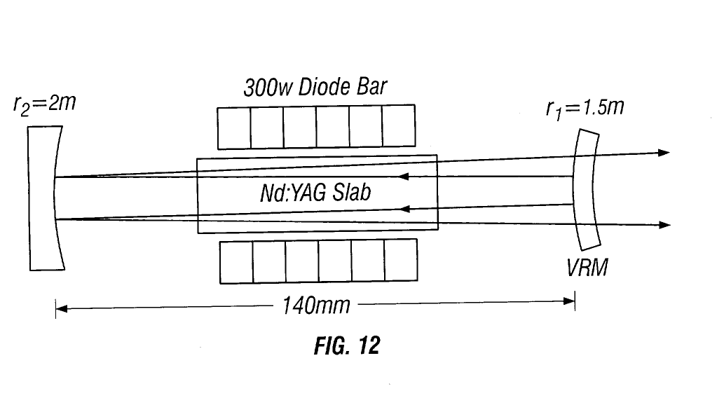

There is shown in FIG. 12 a hybrid resonator with positive branch resonator. The resonator comprises a convex VRM output coupler (OC) mirror and a concave or flat high reflecting (HR) mirror, \which may be selected to compensate for thermal lensing according to standard principles of laser design. The optics are cylindrical so as to accommodate the asymmetric properties of the hybrid resonator. Thus, in the small direction, the mirrors have long radii of curvature defining a stable resonator. The curvatures and the distances of the mirrors from the slab are selected according to known principles of Gaussian beam mode matching, and including the effect of thermal lens of the slab, such that only low order mode will couple efficiently into the slab. For the slab dimensions used in this example, a resonator length of 14 cm and mirror curvatures of 2 m and 1.5 m for the HR and the OC mirrors respectively were found to provide good mode discrimination against higher order modes. The parameters for the VRM output coupler were n=4, w=4 mm and R₀=67%.

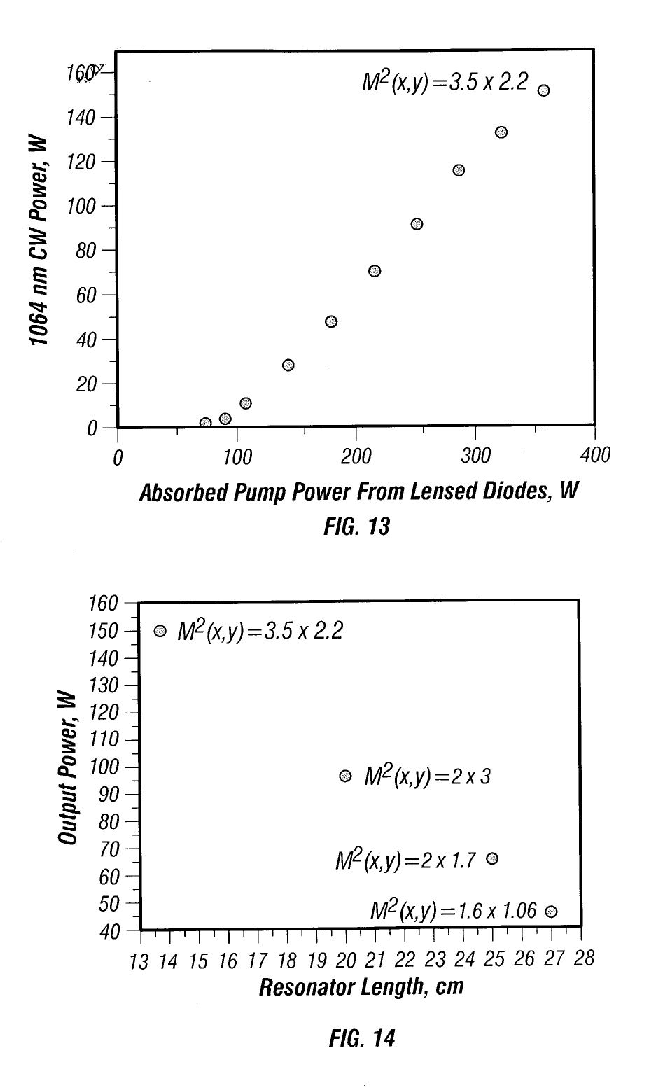

Results with this hybrid resonator are shown in FIG. 13 for the 0.7 mm thick sapphire-bonded slab used earlier. As shown beam quality of 3.5×2.2 is obtained even powers as high as 160 W for relatively unoptimized resonator construction. Still better beam quality may be obtained by going to longer cavity length but at the expense of output power as shown in FIG. 14. The variation of beam quality and output power as a function of cavity length is a result of trade-offs between thermal lensing compensation and resonator stability considerations. Thus, the closer to confocal the resonator is, the higher is the beam quality but this is achieved at the expense of output power because of uncompensated thermal lens. These are however, standard considerations in the art of resonator design, and are indicative of the scalability of the approach of this invention.

Results obtained for the uncoated, unclad, 1 mm thick slab using lensed bar pumping also showed the improvement in the beam quality that can be obtained by implementing a hybrid resonator. with M² values of 1.9×2.2 were demonstrated in this case, even at output power levels as high as 190 W. Cavity length of 138 mm and 50% output coupling were used in these last experiments. It is projected that, using the edge-pumped, thin slab approach, even better beam quality can be obtained with a more optimized resonator as indicated in FIG. 15, which shows the projected variation in M² as a function of the pump power. Ideally, with little or no aberrations due to thermal degradation M² would increase very slightly, even for powers levels exceeding 400 W. Parameters used for this plot were R₀=0.7, n=6, magnification of 1.33, and output coupling of 52.5%. With this choice of parameters, it is estimated that 90% of the far field power content would be in the main peak, corresponding to a beam propagation parameter M² of less than 1.35 in either axis.

Note that although the above hybrid resonator constructions utilized a positive branch unstable resonator, alternative constructions based on negative branch design may be employed in certain cases. While negative branch resonators are known to provide better stability characteristics, they can present some difficult design issues. Among other problems, an intracavity focus, can lead to overly long resonators as well as degraded spatial beam profiles. Folded cavities can however be implemented to reduce the physical size at some added cost in optical complexity, as is known from the art of resonator design. It is further noted that while negative branch hybrid resonators have been used successfully for CO₂ slab waveguide lasers, implementation for solid thin slab materials has not been disclosed prior to the present invention. These and other similar and alternative resonator and cavity configurations known from the art of laser design fall within the scope of the present invention. These include an off-axis resonator an example of which is shown in FIG. 16 for a solid state thin slab laser.

FIG. 16 illustrates an off-axis hybrid resonator configurations that may be implemented as part of the present invention.

In another embodiment of the present invention, Q-switched and mode-locked operation are provided where modulator 8 shown in FIG. 1 is selected from a class of electro-optic or acousto-optic switches. For the thin Nd:YAG slab parameters described above, it is estimated that Q-switched powers in excess of 200 W will be obtained at repetition rates of 40 kHz for input powers of 600 W. In preliminary experiments using an AO Q-Switch in a 20 cm long hybrid cavity, nearly 100 W Q-switched pulses were obtained at repetition rates of up to 50 kHz. Pulses were less than 30 nm long at 10 kHz.

In another embodiment, diode-pumped slab laser resonator 1 can be operation at 3 μm, typically from Er and Ho doped materials. Since these are known to have relatively low gains and high thresholds, thin slab constructions with a very small dimension are advantageously utilized. One example, an Er:YAG slab with a thickness that is less than about 0.6 mm is constructed as a metallic or ceramic coated rectangular slab. At this wavelength, multimode guiding of the signal is achieved along the thin dimension. Single mode operation can however be obtained by exploiting mode discrimination properties using stable resonator design properties similar to those previously implemented for CO₂ waveguide lasers. Although the application of such principles for mode discrimination were known for prior art hybrid resonators for gas lasers, the waveguide structure provided in this invention does not follow prior art teachings for solid state waveguide structures, and therefore represents a novel application of techniques and constructions disclosed in the present invention.

The foregoing description of a preferred embodiment of the invention has been presented for purposes of illustration and description. It is not intended to be exhaustive or to limit the invention to the precise forms disclosed. Obviously, many modifications and variations will be apparent to practitioners skilled in this art. It is intended that the scope of the invention be defined by the following claims and their equivalents.

What is claimed is:

1. An optical system, comprising:
a high reflector and an output coupler defining a resonator cavity with an optical axis;
a slab gain medium positioned in the resonator cavity, the slab gain medium being configured to provide propagation of an optical laser beam along the optical axis through the slab medium;
a first diode pump source producing a first pump beam incident on the slab gain medium in a direction perpendicular to the optical axis; and
a cooling member coupled to the slab gain medium and providing cooling in a direction perpendicular to the optical axis and to the direction of the first pump beam.

2. The system of claim 1, wherein the cooling member includes first and second cooling elements positioned to provide conduction cooling of the gain medium from two opposing sides.

3. The system of claim 2, further comprising:
first and second thermal interface layers positioned between the gain medium and the first and second cooling elements.

4. The optical system of claim 2, wherein the first and second cooling members are positioned to provide a temperature gradient in the gain medium that is perpendicular to a plane of propagation of the pump beam in the gain medium.

5. The system of claim 1, wherein the first diode pump source is a diode array stack.

6. The system of claim 1, further comprising:
at least one collimating optical element positioned between the first diode pump source and the slab gain medium.

7. The system of claim 1, further comprising:
at least one optical element positioned between the first diode pump source and the slab gain medium to collimate the first pump beam.

8. The system of claim 6, wherein the collimating optical element includes a cylindrical lens.

9. The system of claim 5, wherein the diode array stack is configured to provide a collimated pump incident on the slab gain medium.

10. The system of claim 9, wherein the diode array stack is a multiplicity of diode bars arrayed horizontally.

11. The system of claim 10, wherein the emission wavelength of the diode bars are individually adjusted.

12. The system of claim 10, wherein each bar in the stack is individually collimated using a cylindrical optical element.

13. The system of claim 1, wherein the first diode pump source is a fiber coupled array configured to pump along a longest dimension of the slab gain medium.

14. The system of claim 1 wherein the emission wavelength of the first diode pump source is adjusted to obtain uniform absorption profile across the slab in the direction of the optical pump beam.

15. The system of claim 1, wherein an aspect ratio of the optical laser beam is substantially equally to an aspect ratio of a cross section of the slab gain medium.

16. The system of claim 1, wherein the resonator cavity is a hybrid resonator that is stable in a first direction and unstable in a second orthogonal direction.

17. The system of claim 16, wherein the hybrid resonator cavity produces an output beam with a M² of less than 2 in both stable and unstable directions.

18. The system of claim 1, wherein the resonator cavity produces an output beam with a power that is greater than 100 W.

19. The system of claim 1, further comprising:
at least one optical element coupled to the slab gain medium and configured to produce a spatially symmetrized beam.

20. The system of claim 1, wherein the slab gain medium is a composite slab configured to guide a signal laser beam through an active layer.

21. The system of claim 1, wherein the slab gain medium is a composite designed and configured to guide the pump light so as to affect multiple passes through an absorbing active layer.

22. The system of claim 20, wherein the slab composite is formed from one or more materials, forming a central absorbing section sandwiched between two nonabsorbing layers

23. The system of claim 20, wherein the composite slab is a central active layer positioned between first d second dielectric members each having a lower index of refraction than the index of refraction of the active layer.

24. The system according to claim 15.1, wherein the composite
slab is several layers configured as a planar double clad structure.

25. The system of claim 1, wherein the resonator cavity includes a Q-switch.

26. The system of claim 24, wherein the Q-switch is an acousto-optic modulator.

27. The system of claim 24, wherein the Q-switch is an electro-optic modulator.

28. The system of claim 25, wherein the resonator cavity produces a pulsed output beam with a power greater than 100W.

29. The system of claim 16, wherein the hybrid resonator cavity includes a modulator.

30. The system of claim 29, wherein the modulator is a Q-switch

31. The system of claim 29, wherein the modulator is a mode locker.

32. The system of claim 1, further comprising:
a coating on a surface of the slab gain medium, wherein the coating is selected to provide back reflections of the first pump beam.

33. The system of claim 1, further comprising:
a second diode pump source that produces a second pump beam incident on the slab gain medium in a direction opposing a direction of the first pump beam.

34. A laser structure, comprising:
a high reflector and an output coupler defining a resonator cavity with an optical axis;
a slab gain medium positioned in the resonator cavity and having an aspect ratio greater than 5, the slab medium being configured to provide propagation of an optical laser beam along the optical axis through the slab medium;
a cooling member coupled to the slab gain medium; and
a first diode pump source producing a first pump beam incident on the slab gain medium in a direction perpendicular to the optical axis.

35. The structure of claim 34, wherein the slab gain medium includes top and bottom surfaces, first and second side surfaces and first and second end faces, and the cooling member is coupled to the top and bottom surfaces.

36. The structure of claim 35, wherein the first pump beam is incident on the first side surface of the slab gain medium.

37. The structure of claim 35, wherein the first pump beam propagates in a direction parallel to the first and second end faces.

38. The system of claim 34, wherein the resonator cavity is a hybrid resonator that is stable in a first direction and unstable in a second orthogonal direction.

39. The system of claim 38, wherein the hybrid resonator cavity produces an output beam with an M² of less than 2.

40. The system of claim 34, wherein the resonator cavity produces an output beam with a power greater than 100 W.

41. The system of claim 34, wherein the resonator cavity produces an output beam with a power greater than 300 W.

42. The system of claim 36, further comprising:
a second diode pump source that produces a second pump beam incident on the slab gain medium in a direction opposing a direction of the first pump beam.

43. The system of claim 36, further comprising:
a coating on a second side surface of the slab gain medium, wherein the coating is selected to provide back reflections of light.

44. The structure of claim 34, further comprising:
a modulator coupled to the resonator.

45. The structure of claim 44, wherein the modulator is a Q-switch.

46. The system of claim 45, wherein the Q-switch is an acousto-optic modulator.

47. The system of claim 46, wherein the Q-switch is an electro-optic modulator.

48. The system of claim 34, wherein the slab gain medium has an aspect ratio of less than about 40.

49. A laser structure, comprising:
a high reflector and an output coupler defining a resonator cavity with an optical axis;
a slab gain medium positioned in the resonator cavity, the slab gain medium including top and bottom surfaces, first and second side surfaces and first and second end faces;
a cooling member coupled to the top and bottom surfaces;
a first diode pump source producing a first pump beam incident on a full face of at least one of the first and second side surfaces; and
wherein an optical beam propagates in the slab gain medium in a plane that is parallel to at least one of the top and bottom surfaces.

50. The structure of claim 49, wherein the slab gain medium has an aspect ratio greater than 5.

51. The structure of claim 49, wherein the slab gain medium has an aspect ratio less than about 40.

52. The structure of claim 49, wherein the cooling member is configured to provide cooling in a direction perpendicular to the optical axis and the direction of the first pump beam.

53. The structure of claim 49, wherein the first pump beam propagates in a direction parallel to the first and second end faces.

54. The structure of claim 49, further comprising:
at least a second diode pump source that produces a second pump beam that is incident on the second side surface of the slab gain medium, and wherein the first pump beam is incident on the first side surface of the slab gain medium.

55. The structure of claim 49, wherein the resonator is a hybrid resonator

56. The structure of claim 55, wherein the resonator produces a high quality optical laser beam with an M² no greater than 3 in any two orthogonal directions.

57. The structure of claim 55, further comprising:
one or more optical elements positioned at an exterior of the resonator to circularize an output beam of the resonator.

58. The structure of claim 49, wherein the optical laser beam has a power of at least 100 W.

59. The structure of claim 49, wherein the optical laser beam has a power of at least 300 W.

60. The structure of claim 49, further comprising:
a modulator coupled to the resonator.

61. The structure of claim 60, wherein the modulator is a Q-switch.

62. The structure of claim 49, wherein the slab gain medium has a rectangular geometry.

63. The system of claim 49, further comprising:
a coating on the second side surface of the slab gain medium, the second side surface wherein the first side surface is a pump side surface and the coating is selected to provide back reflections of light.

64. The system of claim 49, wherein the slab gain medium is a composite slab configured to guide a signal laser beam through an active layer.

65. The system of claim 49, wherein the slab gain medium is a composite designed and configured to guide the pump light so as to affect multiple passes through an absorbing active layer.

66. The system of claim 65, wherein the slab composite is formed from one or more materials, forming a central absorbing section sandwiched between two nonabsorbing layer

67. The system of claim 65, wherein the composite slab is a central active layer positioned between first and second dielectric members each having a lower index of refraction than the index of refraction of the active layer.

68. The system according to claim 65, wherein the composite slab is several layers configured as a planar double clad structure.

69. A optical system, comprising:
a high reflector and an output coupler defining a resonator cavity with an optical axis;
a slab gain medium positioned in the resonator cavity and having an aspect ratio less than 50, the slab medium being configured to provide propagation of an optical laser beam along the optical axis through the slab medium;
a cooling member coupled to the slab gain medium; and
a first diode pump source producing a first pump beam incident on the slab gain medium in a direction perpendicular to the optical axis.

70. The system of claim 69, wherein the slab gain medium guides the optical laser beam in the slab gain medium to provide low order modes.

71. The system of claim 69, wherein the slab gain medium is a composite slab configured to guide a signal laser beam through an active layer.

72. The system of claim 69, wherein the slab gain medium is a composite designed and configured to guide the pump light so as to affect multiple passes through an absorbing active layer.

73. The system of claim 72, wherein the slab composite is formed from one or more materials, forming a central absorbing section sandwiched between two nonabsorbing layer

74. The system of claim 72, wherein the composite slab is a central active layer positioned between first d second dielectric members each having a lower index of refraction than the index of refraction of the active layer.

75. The system according to claim 72, wherein the composite slab comprises several layers configured as a planar double clad structure.

76. The system of claim 69, wherein the slab gain medium is configured to guide the first pump beam an increase a pump absorption length in the slab gain medium.

77. An optical system, comprising:
a slab gain medium positioned along an optical axis and having an aspect ratio greater than 5, the slab gain medium being configured to provide propagation of an optical laser beam along the optical axis through the slab medium;
a first diode pump source producing a first pump beam incident on the slab gain medium in a direction perpendicular to the optical axis; and
a cooling member coupled to the slab gain medium and provide cooling in a direction perpendicular to the optical axis and to the direction of the first pump beam.

78. The system of claim 77, further comprising:
input and output mirrors that resonate the optical laser beam.

79. The system of claim 77, wherein the optical system is an amplifier configured to provide amplification of an input signal beam.

80. A method for producing a high quality beam from a diode pumped solid state laser at high power, comprising:
propagating an optical beam through a slab gain medium;
providing an optical system coupled to the slab gain medium that provides pumping, cooling and extraction of an optical beam along axes that are mutually orthogonal;
and producing an output beam with a power of at least 80 W.

81. The method of claim 80, further comprising:
conductively cooling the slab gain medium.

82. The method of claim 80, wherein the optical system is a laser resonator.

83. The method of claim 80, wherein the laser resonator includes a modulator.

84. The method of claim 80, wherein the pumping is provided by a diode laser array.

85. The method of claim 88, wherein the laser diode array is configured as a stack of multiplicity of diode bars horizonatally arrayed along a longer dimension of the slab gain medium.

86. The method of claim 88, wherein the pumping radiation is fiber coupled to the slab gain medium.

87. The method of claim 80, wherein the optical system is configured as an amplifier.

88. A method for producing a high quality beam from a diode pumped solid state laser at high power, comprising:
providing an optical system with a slab gain medium that has a depth, length and a width, wherein the width is selected to maximize absorption from a pumping radiation and the depth is selected to provide a one-dimensional thermal profile;
propagating the optical beam through the slab gain medium; and
producing a beam with a power of at least 80 W

89. The method of claim 88, wherein the width-to-depth aspect ratio is further constrained to be greater than about 5.

90. The method of claim 88, wherein the length of the slab gain medium is selected to maximize the pumping radiation power.

91. The method of claim 88, wherein the wavelength of the pumping radiation is selected to provide a uniform absorption profile across the width of the slab gain medium.

92. The method of claim 88, further comprising:
conductively cooling the slab gain medium.

93. The method of claim 88, wherein the optical system is a laser resonator.

94. The method of claim 88, wherein the optical system is an amplifier.

95. An optical apparatus, comprising:
a slab gain medium positioned in the resonator cavity, the slab gain medium being configured to provide propagation of an optical laser beam along the optical axis through the slab medium;
a first diode pump source producing a first pump beam incident on the slab gain medium in a direction perpendicular to the optical axis; and
a cooling member coupled to the slab gain medium and providing cooling in a direction perpendicular to the optical axis and to the direction of the first pump beam.

96. The laser structure of claim 1, wherein the slab gain medium has a width selected to match a numerical aperture and a lateral dimension of the first pump beam.

97. The laser structure of claim 1, wherein the slab gain medium is made of a material that is not dimensioned as a single mode waveguide in any direction.

98. The laser structure of claim 1, wherein the output beam is a CW beam.

99. The laser structure of claim 1, wherein the output beam is pulsed.

100. The laser structure of claim 1, wherein the output beam has an M² value between 1.5 and 30.

101. The laser structure of claim 1, wherein the output coupler has a graded reflectivity profile.

102. The laser structure of claim 1, wherein at least a portion of the resonator cavity is a positive branch resonator.

103. The laser structure of claim 1, wherein at least a portion of the resonator cavity is a negative branch resonator.

104. The laser structure of claim 1, wherein the resonator cavity is an off-axis resonator.
